(19) United States
(12) Patent Application Publication
(10) Pub. No.: US 2025/0341897 A1
(43) Pub. Date: Nov. 6, 2025

(54) GESTURE-BASED PROCESSING OF DIGITAL HUMAN RESPONSES

(71) Applicant: Dell Products L.P., Round Rock, TX (US)

(72) Inventors: Michael David Shepherd, Leander, TX (US); Jonathan M. Whitson, Mountain Grove, MO (US); Joseph Michael Whitson, Mansfield, MO (US)

(21) Appl. No.: 18/652,936

(22) Filed: May 2, 2024

(51) Int. Cl. G06F 3/01; G06F 3/04815; G06F 3/0488

(52) U.S. Cl. CPC G06F 3/017; G06F 3/016; G06F 3/04815; G06F 3/0488

(57) ABSTRACT

Techniques for gesture-based processing of digital human responses are provided. One method comprises obtaining a response, generated by a language model, to be delivered by a digital human to a user, wherein the response comprises a predicted gesture label identifying a gesture associated with the response; presenting a virtual touch display element to the user, based on the predicted gesture label, wherein the virtual touch display element comprises selectable portions; determining coordinates of a gesture of the user, in connection with a given selectable portion; mapping the determined coordinates of the gesture to a selection of a given item associated with a corresponding one of the selectable portions; and initiating an automated action based on the selected given item. Virtual interactions between the user and the digital human may also be processed. A haptic feedback response may be provided to the user in response to a given gesture.

### BACKGROUND

A digital human is a computer-generated representation of a person that aims to behave like a real person. Users increasingly engage with digital humans in various environments, such as retail environments, training environments and customer support environments, and for various purposes. There are a number of challenges, however, that need to be addressed in order for such digital humans to successfully interact like a real person.

### SUMMARY

Illustrative embodiments of the disclosure provide techniques for gesture-based processing of digital human responses. One method includes obtaining at least one response, generated by at least one language model, to be delivered by at least one processor-based digital human to at least one user, wherein the at least one response comprises at least one predicted gesture label identifying at least one gesture associated with the at least one response; presenting a virtual touch display element to the at least one user, based at least in part on the at least one predicted gesture label, wherein the virtual touch display element comprises a plurality of selectable portions; determining two or more coordinates, in a plurality of dimensions, of at least one gesture of the at least one user, in connection with a given one of the plurality of selectable portions; mapping the determined two or more coordinates of the at least one gesture to a selection of a given item associated with a corresponding one of the plurality of selectable portions; and initiating at least one automated action based at least in part on the selected given item;

Illustrative embodiments can provide significant advantages relative to conventional techniques. For example, technical problems related to such conventional techniques are mitigated in one or more embodiments by presenting a virtual touch display element having selectable portions to a user and determining an item selected by the user by evaluating at least one gesture of the user. Additionally, one or more embodiments can process virtual interactions between the user and the digital human.

These and other illustrative embodiments described herein include, without limitation, methods, apparatus, systems, and computer program products comprising processor-readable storage media.

### BRIEF DESCRIPTION OF THE DRAWINGS

FIG. 1 illustrates an information processing system configured for gesture-based processing of digital human responses in accordance with an illustrative embodiment;

FIG. 2 illustrates a generation of a response for a digital human based at least in part on a user query-based prompt applied to a language model in accordance with an illustrative embodiment;

FIG. 3 illustrates a processing of a conversational dialogue between a user and a digital human using gesture-based processing of digital human responses in accordance with an illustrative embodiment;

FIG. 4 illustrates an exemplary processing of coordinates associated with a particular gesture to orient a digital human towards an area of the particular gesture in accordance with an illustrative embodiment;

FIG. 5 illustrates an exemplary webpage having a number of designated portions that may be of interest to a user in accordance with an illustrative embodiment;

FIG. 6 is a sample table illustrating metadata for the designated portions of FIG. 6 that may be of interest to a user in accordance with an illustrative embodiment;

FIGS. 7 and 8 are flow diagrams illustrating exemplary implementations of a process for gesture-based processing of digital human responses in accordance with illustrative embodiments;

FIG. 9 illustrates an exemplary processing platform that may be used to implement at least a portion of one or more embodiments of the disclosure comprising a cloud infrastructure; and

FIG. 10 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for gesture-based processing of digital human responses.

In one or more embodiments, techniques for gesture-based processing of digital human responses are provided. Sensing data (such as audio and/or video sensor data) related to one or more remote users can be applied to the disclosed digital human adaptation system (comprising, for example, one or more analytics algorithms, such as machine learning (ML) algorithms, artificial intelligence (AI) techniques, computer vision (CV) algorithms and/or data analytics algorithms) to obtain real-time responses for each remote user.

In at least some embodiments, the disclosed digital human adaptation techniques provide a number of technical solutions. For example, in one or more embodiments, the disclosed techniques for gesture-based processing of digital human responses present a virtual touch display element having selectable portions to a user and determine an item selected by the user by evaluating at least one gesture of the user. In addition, one or more embodiments can process virtual interactions between the user and the digital human, such as virtual handshakes, virtual first bumps, virtual high fives and virtual thumbs up.

At least some aspects of the disclosure recognize that users may be less engaged with a digital human than with a real person because physical interactions with the digital human may be slow, reduced or non-existent, which may decrease the rich communication and other dynamics that encourage users to consistently participate in a dialogue. In an in-person physical environment, for example, participants can more easily identify visual cues of a user by evaluating the body language and/or facial expression of participants to obtain an immediate assessment of each participant's interests. In a remote digital human environment, however, it is difficult for participants to evaluate and assess the interests of other participants remotely.

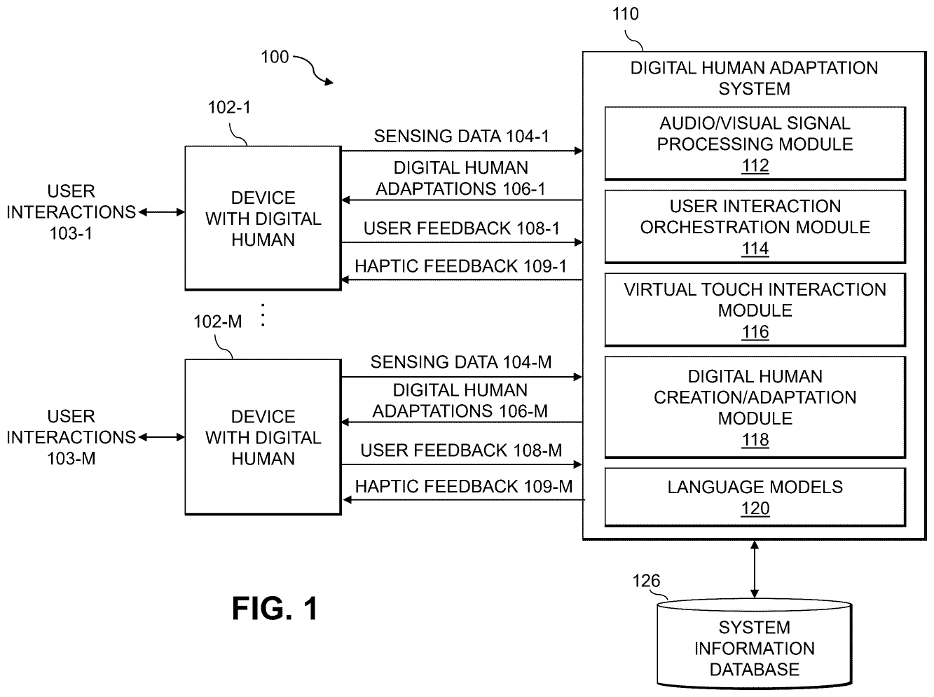

FIG. 1 shows an information processing system 100 configured in accordance with an illustrative embodiment. The information processing system 100 comprises a plurality of devices with a digital human 102-1 through 102-M, collectively referred to herein as digital human devices 102. The digital human devices 102-1 through 102-M interact with one or more respective users to generate respective user interactions 103-1 through 103-M. Generally, artificial intelligence-based chat robots (e.g., chatbots) or other digital humans typically use one or more machine learning models to understand a context and an intent of a question asked by a user before providing an answer. The digital human devices 102 may be implemented, for example, as a user device presenting a digital human, a kiosk presenting a digital human, and/or a device that presents a digital human using a holograph and/or a three-dimensional or lenticular display. The information processing system 100 further comprises one or more digital human adaptation systems 110 and a system information database 126, discussed below.

The digital human devices 102 may comprise, for example, host devices and/or devices such as mobile telephones, laptop computers, tablet computers, desktop computers, kiosks, holographic devices, three-dimensional displays or other types of computing devices (e.g., virtual reality (VR) devices or augmented reality (AR) devices). Such devices are examples of what are more generally referred to herein as “processing devices.” Some of these processing devices are also generally referred to herein as “computers.” The digital human devices 102 may comprise a network client that includes networking capabilities such as ethernet, Wi-Fi, etc. The digital human devices 102 may be implemented, for example, by participants of a customer support interaction, such as one or more users or customers and one or more virtual customer support representatives.

One or more of the digital human devices 102 and the digital human adaptation system 110 may be coupled to a network, where the network in this embodiment is assumed to represent a sub-network or other related portion of a larger computer network. The network is assumed to comprise a portion of a global computer network such as the Internet, although other types of networks can be part of the computer network, including a wide area network (WAN), a local area network (LAN), a satellite network, a telephone or cable network, a cellular network, a wireless network such as a Wi-Fi or WiMAX network, or various portions or combinations of these and other types of networks. The network in some embodiments therefore comprises combinations of multiple different types of networks, each comprising processing devices configured to communicate using internet protocol (IP) or other related communication protocols.

The digital human devices 102 and/or the digital human adaptation system 110 in some embodiments comprise respective devices and/or servers associated with a particular company, organization or other enterprise. In addition, at least portions of the information processing system 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, such as avatar or other computer-generated representations of a human, as well as various combinations of such entities. Compute and/or storage services may be provided for users under a Platform-as-a-Service (PaaS) model, an Infrastructure-as-a-Service (IaaS) model, a Storage-as-a-Service (STaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of edge devices, or a stand-alone computing and storage system implemented within a given enterprise.

One or more of the digital human devices 102 and the digital human adaptation system 110 illustratively comprise processing devices of one or more processing platforms. For example, the digital human adaptation system 110 can comprise one or more processing devices each having a processor and a memory, possibly implementing virtual machines and/or containers, although numerous other configurations are possible. The processor illustratively comprises a microprocessor, a microcontroller, an application-specific integrated circuit (ASIC), a field-programmable gate array (FPGA) or other type of processing circuitry, as well as portions or combinations of such circuitry elements.

One or more of the digital human devices 102 and the digital human adaptation system 110 can additionally or alternatively be part of cloud infrastructure or another cloud-based system.

In the example of FIG. 1, each digital human device 102-1 through 102-M provides corresponding sensing data 104-1 through 104-M, collectively referred to herein as sensing data 104, associated with the respective user to the digital human adaptation system 110. For example, the sensing data 104 may be generated by cameras, microphones, IoT sensors or other sensors near the respective users that can be used for data collection, including audio signals, video signals, physiological data, motion and emotion data. The sensors may be embedded within existing digital human devices 102, such as graspable and touchable user devices (e.g., computer, monitor, mouse, keyboards, smart phone and/or AR/VR headsets). The sensors may also be implemented as part of laptop computer devices, smart mobile devices or wearable devices on the body of a user, such as cameras, microphones, physiological sensors and smart watches.

In addition, each digital human device 102-1 through 102-M can receive digital human adaptations 106-1 through 106-M, collectively referred to herein as digital human adaptations 106, from the digital human adaptation system 110. The digital human adaptations 106 can be initiated, for example, to present and/or adjust a digital human on the respective digital human device 102, or to provide specific information to a respective user (e.g., requested information and/or topic summaries) and/or to stimulate the respective user if the respective user is detected to have a different sentiment or level of engagement than expected.

Further, each digital human device 102 can provide user feedback 108-1 through 108-M, collectively referred to herein as user feedback 108, to the digital human adaptation system 110 indicating, for example, an accuracy of information provided by the digital human on the digital human device 102 to a respective user (e.g., to fine tune an analytics engine or another model associated with the digital human adaptation system 110), special circumstances associated with the respective user and/or feedback regarding particular recommendations or suggestions made by the digital human adaptation system 110 in the form of digital human adaptations 106.

In some embodiments, users can receive or request information from the digital human on the digital human device 102, and provide the user feedback 108 back to the digital human adaptation system 110 indicating whether the digital human response or recommendations are accurate, thereby providing a closed loop learning system. The user feedback 108 indicating the accuracy of the digital human response or recommendations can be used to train and/or retrain one or more models employed by the digital human adaptation system 110.

In some embodiments, each digital human device 102 can receive additional feedback from the digital human adaptation system 110 based at least in part on the user interactions 103 of the respective user with the digital human. For example, the digital human adaptations 106 for a given user may comprise a text signal (e.g., to be transformed into a voice signal by the digital human), a voice message, graphical information and/or manipulations of the position, emotion and/or rotation of the digital human, or a combination of the foregoing, to provide targeted information, an alert and/or instructions to the given user during a digital human session.

The digital human adaptations 106 can be automatically generated, for example, if users are detected to have a negative sentiment or to be distracted (e.g., when the measured engagement level falls below a threshold or deviates from another criteria). For example, a voice message can ask if a user needs assistance during a digital human session, when the user fails to speak within a designated time period, or when the user is stressed or uninterested, for example. The digital human adaptations 106 could be specifically designed based on different scenarios.

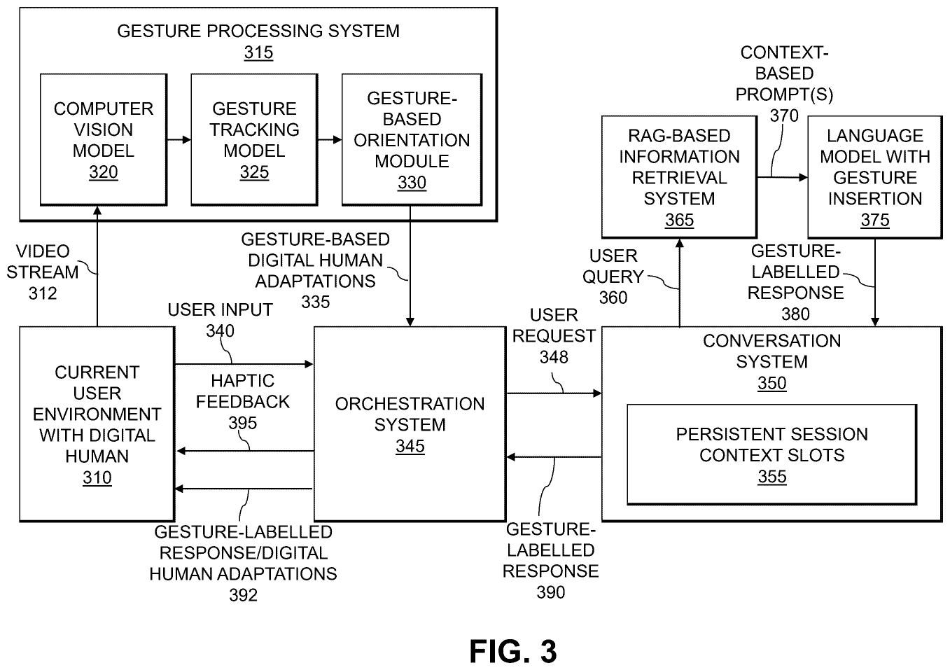

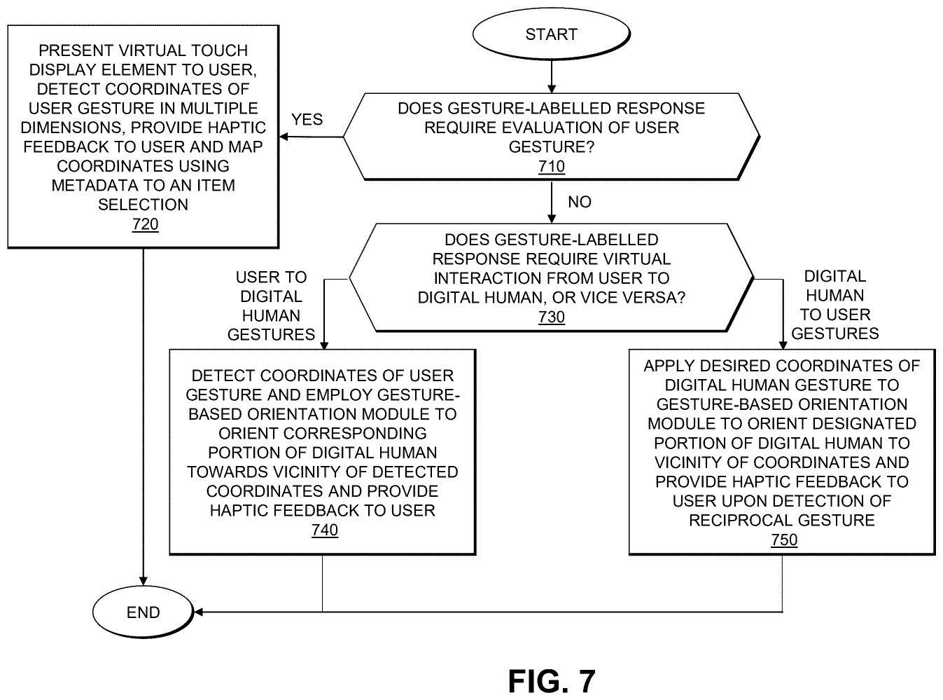

The digital human adaptation system 110 may provide haptic feedback 109-1 through 109-M to one or more respective digital human devices 102, as discussed further below in conjunction with FIGS. 3 and 7, for example. The haptic feedback 109 can be initiated, for example, in response to, or as part of, a given gesture. The haptic feedback 109 can be automatically provided as a stimulus, warning or alert to a disengaged user, for example. Haptics can also be used as a mechanism for providing feedback about the actions and/or tasks of a user, or can be combined with a gesture from a digital human to make the user experience more vivid or lifelike. Patterns of haptic feedback may be customized, for example, based on different scenarios or use cases.

The haptic feedback 109 can be generated, for example, using vibrators and/or sound (e.g., ultrasound) generators or modulators available within the digital human device 102 associated with a given user. In a further variation, the haptic feedback 109 can be generated, for example, using an independent haptic wearable device (e.g., a wrist band, a haptic glove, a haptic hand tracking device and/or a haptic vest).

The following haptic technologies may be employed in some embodiments to deliver the haptic feedback 109 to a respective user:
vibrotactile haptics (e.g., tiny motors that create vibrations and other tactile effects in mobile phones, game controllers and VR controllers);
ultrasonic mid-air haptics (where algorithms control ultrasound waves so that the combined pressure of the waves interacting produces a force that can be felt on the hands of a user, for example; the “virtual touch” haptic technology means that the user does not need to be in contact with a physical surface thereby reducing a spreading of germs, for example);
microfluidics (where air or liquid is pushed into tiny chambers within a smart textile or other device, creating pockets of pressure or temperature on a user's skin);
force control (where levers or other large-scale mechanical devices are used to exert force on, for example, the hands, limbs or another portion of a user's body); and
surface haptics (that modulate friction between a user's finger, for example, and a touchscreen to create tactile effects).

In one or more embodiments, the haptic feedback 109 may employ different types of haptic patterns, for example, with customized sharpness and intensity. A wide range of different haptic experiences may be achieved by combining transient and continuous haptic events, varying sharpness and intensity, and including optional audio content. The patterns of haptic feedback could be specifically designed based on different scenarios. For example, in a digital human environment, the following exemplary haptic feedback options can be employed:
notification haptics to provide feedback about the outcome of a task, selection or action from a user (such as providing a vibration and/or a sound of applause to: (i) provide praise and/or encouragement to a user, (ii) ask if a user understands the presented information or needs help, and/or (iii) echo an opinion or statement presented by a digital human).
warning haptics to indicate an error or other warning associated with a behavior of a user; and
impact haptics to provide a physical metaphor that can be used to complement a visual experience (e.g., during a visual presentation to make the presented content more vivid).

As shown in FIG. 1, the exemplary digital human adaptation system 110 comprises an audio/visual signal processing module 112, a user interaction orchestration module 114, a virtual touch interaction module 116, a digital human creation/adaptation module 118 and at least one language model 120, as discussed further below.

In one or more embodiments, the audio/visual signal processing module 112 may be used to collect and/or process audio/visual data and other sensing data 104 and to optionally perform one or more (i) sensor data pre-processing tasks, (ii) audio/visual analysis tasks and/or (iii) audio/visual tracking tasks, for example. The user interaction orchestration module 114 coordinates the user interactions 103 between the digital human devices 102 and the respective users with one or more backend portions of the digital human adaptation system 110, for example. The exemplary virtual touch interaction module 116 presents a virtual touch display element having selectable portions to a user and determines an item selected by the user by evaluating at least one gesture of the user. In addition, the virtual touch interaction module 116 may optionally process virtual interactions between the user and the digital human, such as virtual handshakes, virtual first bumps, virtual high fives and virtual thumbs up.

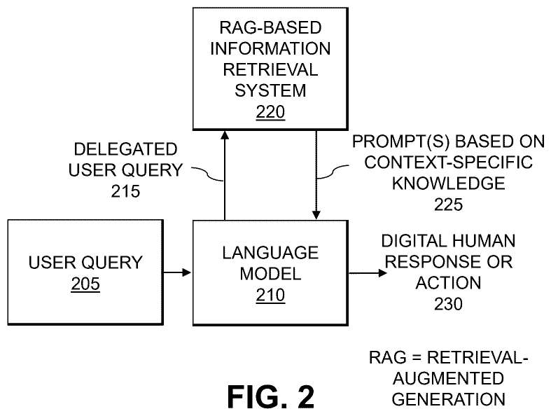

One or more context-based prompts may be applied in some embodiments to at least one language model 120, such as a large language model or another model that can generate text and perform natural language processing (NLP) tasks, that determines a response for a user of a respective digital human device 102, as discussed further below in conjunction with FIGS. 2 and 3, for example. The at least one language model 120 may learn statistical relationships from a training dataset comprised of text documents using a self-supervised training process and/or a semi-supervised training process. The at least one language model 120, in some embodiments, may combine a partial response based on results from a user query and/or a partial response of the at least one language model 120 based on its own information into a final response.

The term “language model” as used herein is intended to be broadly construed so as to encompass, for example, natural language processing models trained on textual data to understand, generate, predict and/or summarize new content. The at least one language model 120 may be implemented, for example, using transformer-based architectures that process input through a sequence of transformers, where each transformer includes a self-attention layer and feedforward layer. Generally, a self-attention layer computes an importance of each token in a sequence of input tokens, and a feedforward layer transforms the output of the self-attention layer into a form that is suitable for the next transformer in the sequence.

The digital human creation/adaptation module 118 generates a given digital human presented on a respective digital human device 102 and/or one or more digital human adaptations 106 to one or more of the digital human devices 102, as discussed further below. The digital human creation/adaptation module 118 may be implemented, at least in part, using an Unreal Engine three-dimensional computer graphics tool, commercially available from Epic Games, Inc., as modified herein to provide the features and functions of the present disclosure.

It is to be appreciated that this particular arrangement of elements 112, 114, 116, 118, 120 illustrated in the digital human adaptation system 110 of the FIG. 1 embodiment is presented by way of example only, and alternative arrangements can be used in other embodiments. For example, the functionality associated with elements 112, 114, 116, 118, 120 in other embodiments can be combined into a single elements, or separated across a larger number of elements. As another example, multiple distinct processors and/or memory elements can be used to implement different ones of elements 112, 114, 116, 118, 120 or portions thereof. At least portions of elements 112, 114, 116, 118, 120 may be implemented at least in part in the form of software that is stored in memory and executed by a processor.

The digital human adaptation system 110 may further include one or more additional modules and other components typically found in conventional implementations of such devices, although such additional modules and other components are omitted from the figure for clarity and simplicity of illustration.

In the FIG. 1 embodiment, the digital human adaptation system 110 is assumed to be implemented using at least one processing platform, with each such processing platform comprising one or more processing devices, and each such processing device comprising a processor coupled to a memory. Such processing devices can illustratively include particular arrangements of compute, storage and network resources.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for different instances or portions of the digital human adaptation system 110 to reside in different data centers. Numerous other distributed implementations of the components of the system 100 are possible.

As noted above, the digital human adaptation system 110 can have an associated system information database 126 configured to store information related to one or more of the digital human devices 102, such as sensing, AR and/or VR capabilities, user preference information, static digital human topologies and a digital human datastore. Although the system information is stored in the example of FIG. 1 in a single system information database 126, in other embodiments, an additional or alternative instance of the system information database 126, or portions thereof, may be incorporated into the digital human adaptation system 110 or other portions of the system 100.

The system information database 126 in the present embodiment is implemented using one or more storage systems. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with one or more of the digital human devices 102 and the digital human adaptation system 110 can be one or more input/output devices (not shown), which illustratively comprise keyboards, displays or other types of input/output devices in any combination. Such input/output devices can be used, for example, to support one or more user interfaces to a digital human device 102, as well as to support communication between the digital human adaptation system 110 and/or other related systems and devices not explicitly shown in FIG. 1.

The memory of one or more processing platforms illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

It is to be understood that the particular set of elements shown in FIG. 1 for digital human adaptation is presented by way of illustrative example only, and in other embodiments additional or alternative elements may be used. Thus, another embodiment includes additional or alternative systems, devices and other network entities, as well as different arrangements of modules and other components.

One or more aspects of the disclosure recognize that existing digital humans lack an ability to predict questions of a user simply through observation. While humans can notice where a person is looking and ask them a question about the item they are looking at, a digital human needs an awareness of where the person is looking and what aspects of a display screen, for example, are being looked at.

FIG. 2 illustrates a generation of a response for a digital human based at least in part on a user query-based prompt applied to a language model in accordance with an illustrative embodiment. In the example of FIG. 2, a user query 205 is applied to a language model 210. The user query 205 may be an explicit question asked by a user (e.g., as part of a conversational dialoguc) and/or an implied question inferred from behavior of the user, such as a predicted region of interest to the user based at least in part on what the user is looking at (e.g., which may suggest what a person is thinking about and may be used to initiate and/or continue a dialogue with the user). In this manner, one or more embodiments of the present disclosure provide for intelligent prompt injection to the language model 210 using a retrieval-augmented generation (RAG)-based information retrieval system 220 to benefit the conversational flow.

The language model 210 (or another backend element of the digital human adaptation system 110) may delegate the user query 205, in some embodiments, as a delegated user query 215 to the RAG-based information retrieval system 220. The RAG-based information retrieval system 220 receives the delegated user query 215 as an input and performs one or more information retrieval operations. The response from the RAG-based information retrieval system 220 may be in the form of ranked results in some embodiments, and the top N results (e.g., the highest-ranking result) may be applied to the language model 210 as one or more prompts (e.g., based at least in part on a prompt size limit).

The RAG-based information retrieval system 220 generates one or more prompts 225 based on context-specific knowledge obtained using the delegated user query 215. RAG is a technique for enhancing the accuracy and/or reliability of generative artificial intelligence models, such as the language model 210, with information obtained from external sources. The prompts 225 ground the language model 210 in some embodiments using one or more external sources of knowledge that supplement the internal representation of information by the language model 210. The RAG-based information retrieval system 220 may be implemented, at least in part, in some embodiments, using the Pryon answer engine, commercially available from Pryon Inc. and/or the information retrieval functionality of the Milvus open-source vector database system.

The one or more prompts 225 are applied to the language model 210 that generates a digital human response or action 230 (e.g., relevant information and responses based on a conversational dialogue and/or the user's region of interest). The language model 210 may combine the retrieved words in the one or more prompts 225 with its own response to the user query 205 into a final digital human response or action 230. The digital human response or action 230 may be communicated to the user, for example, using the digital human creation/adaptation module 118, as discussed herein. The digital human response or action 230 may comprise relevant information and responses based on a conversational dialogue and/or what the user was looking at.

For additional discussions of digital human adaptation techniques, see, for example, United States Patent Application entitled “Orienting Digital Humans Towards Isolated Speaker,” (Attorney Docket No. 138393.01); United States Patent Application entitled “Selecting Isolated Speaker Signal by Comparing Text Obtained from Audio and Video Streams,” (Attorney Docket No. 138394.01); United States Patent Application entitled “Phoneme-Based Pronunciations for Digital Humans,” (Attorney Docket No. 138395.01); United States Patent Application entitled “Sentiment-Based Adaptation of Digital Human Responses,” (Attorney Docket No. 138396.01); United States Patent Application entitled “Automatically Generating Language Model Prompts Using Predicted Regions of Interest,” (Attorney Docket No. 138397.01); United States Patent Application entitled “Pause-Based Text-To-Speech Processing for Digital Humans,” (Attorney Docket No. 138398.01); United States Patent Application entitled “Identity-Based Varied Digital Human Responses,” (Attorney Docket No. 138399.01); United States Patent Application entitled “Reinstantiating Digital Humans With Stored Session Context in Response to Device Transfer,” (Attorney Docket No. 138400.01); United States Patent Application entitled “Reinstantiating Digital Humans With Stored Session Context in Response to Navigation to a Different Destination,” (Attorney Docket No. 138401.01); and United States Patent Application entitled “Personalizing Vehicles Using Digital Humans to Administer User Preferences,” (Attorney Docket No. 138402.01), each filed contemporaneously herewith and incorporated by reference herein in its entirety

FIG. 3 illustrates a processing of a conversational dialogue between a user and a digital human using gesture-based processing for digital humans in accordance with an illustrative embodiment. In the example of FIG. 3, a user may interact with a digital human displayed on a webpage, for example, to provide a user input 340 (e.g., by asking the digital human a question). One or more video streams 312 from a current user environment with a digital human 310, is applied to a gesture processing system 315. The gesture processing system 315 comprises a computer vision model 320, a gesture tracking model 325 and a gesture-based orientation module 330. The current user environment with the digital human 310 may comprise, for example, a user interface, one or more cameras (e.g., to generate the one or more video streams 312) and an ultrasound wave modulator, for example, to provide haptic feedback to the user.

The computer vision model 320 in some embodiments may comprise a pre-trained computer vision model (e.g., pre-trained using reference and/or authenticated component images) such as, for example, a model based on at least one convolutional neural network. The computer vision model 320 may preprocess one or more images in the video stream 312 for further processing by the gesture tracking model 325 that determines a gesture performed by the at least one user, for example, using a convolutional neural network (CNN) model, such as a region-based CNN (R-CNN) model to perform gesture prediction. In an embodiment, the gesture tracking model 325 (e.g., a hand gesture recognition model) may be implemented using the techniques described in, for example, Chi-Man Pun et al., “Real-Time Hand Gesture Recognition using Motion Tracking,” International Journal of Computational Intelligence Systems 4 (2), April 2011, incorporated by reference herein in its entirety.

The computer vision model 320 may perform object detection and isolate objects of interest (such as faces, lips, hands or other body parts) using bounding boxes and/or cropping techniques to create rectangular image snippets, for example. The computer vision model 320 may be implemented using the techniques described in, for example, Abhinav Veeramalla, “Face Detection and Cropping using OpenCV in Python,” (Medium, Jul. 12, 2023), incorporated by reference herein in its entirety. In some embodiments, the computer vision model 320 may perform a loop for each detected body part, extract the desired body parts from the image, standardize a size of the extracted body part (e.g., a cropped hand or face) and provide the coordinates of the cropped body part (such as 200×200 rectangular pixels). The gesture tracking model 325 processes the cropped output of the computer vision model 320 and determines coordinates of the desired body part in the image (such as a hand, for example). In one or more variations, the functionality of the computer vision model 320 and the gesture tracking model 325 may alternately be performed by a hand tracking device and/or a haptic glove, as would be apparent to a person of ordinary skill in the art.

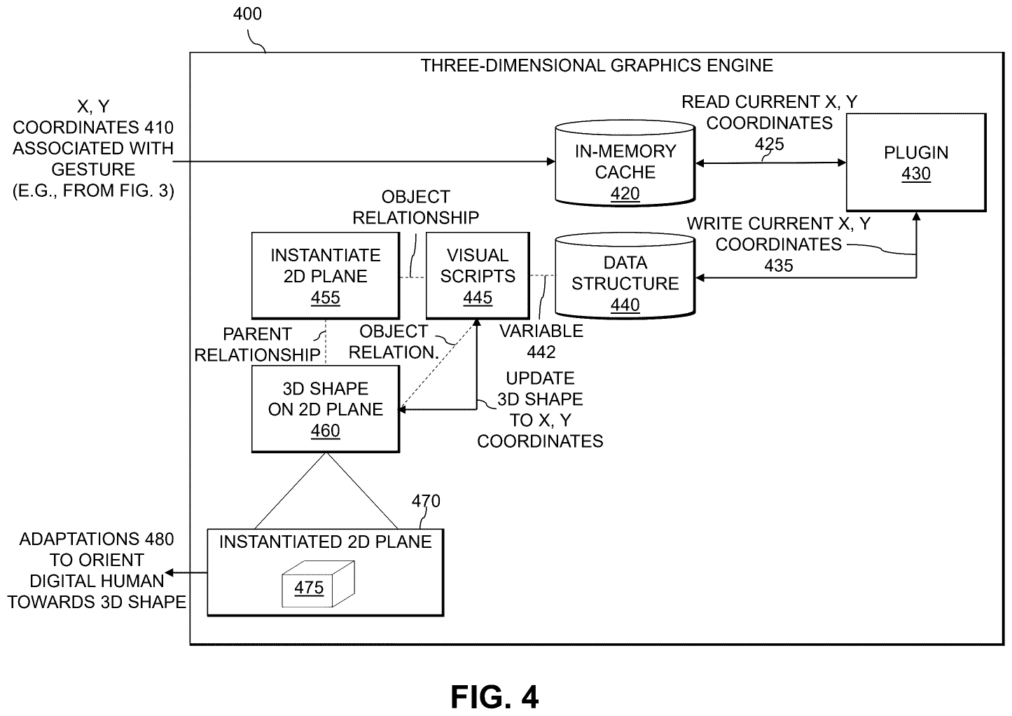

The gesture-based orientation module 330 generates one or more gesture-based digital human adaptations 335, as discussed further below in conjunction with FIG. 4.

As shown in FIG. 3, the user input 340, from the current user environment with the digital human 310, is applied to an orchestration system 345. The orchestration system 345 provides the user input 340 to a conversation system 350 in the form of a user request 348. In one or more embodiments, the conversation system 350 processes the user request 348; manages a flow, context and session state of each conversation; understands user queries and generates appropriate responses based on information retrieval techniques and language model responses, as discussed hereinafter.

In some embodiments, the conversation system 350 comprises one or more persistent session context slots 355 (e.g., tracker slots). The stored session context information allows a digital human to remember previous interactions and other data associated with specific sessions.

The conversation system 350 receives the user request 348 and provides the user request 348, in the form of a user query 360, to a retrieval-augmented generation (RAG)-based information retrieval system 365 to benefit the conversational flow. The RAG-based information retrieval system 365 receives the user query 360 as an input and performs one or more information retrieval operations. The response from the RAG-based information retrieval system 365 may be in the form of ranked results in some embodiments, and the top N results (e.g., the highest-ranking result) may be applied to a language model 375 (e.g., a language model trained to perform gesture insertion) as one or more context-based prompts 370 (e.g., based at least in part on a prompt size limit). In some embodiments, the language model 375 may be locally trained and implemented using one or more edge devices.

The RAG-based information retrieval system 365 generates one or more context-based prompts 370 based on context-specific knowledge obtained using the user query 360. RAG is a technique for enhancing the accuracy and/or reliability of generative artificial intelligence models, such as the language model 375, with information obtained from external sources. The context-based prompts 370 ground the language model 375 in some embodiments using one or more external sources of knowledge that supplement the internal representation of information by the language model 375. As noted above, the RAG-based information retrieval system 365 may be implemented, at least in part, in some embodiments, using the Pryon answer engine, commercially available from Pryon Inc. and/or the information retrieval functionality of the Milvus open-source vector database system.

The one or more context-based prompts 370 are applied to the language model 375 that generates a gesture-labelled digital human response 380 (e.g., relevant information and responses based on a conversational dialogue and/or the user's region of interest, with gesture labels inserted where appropriate). The language model 375 may combine the retrieved words in the one or more context-based prompts 370 with its own response to the user request 348 into a gesture-labelled digital human response 380. The gesture-labelled digital human response 380 may be communicated to the user, for example, using the digital human creation/adaptation module 118, as discussed herein.

The gesture-labelled digital human response 380 may comprise relevant information and responses based on a conversational dialogue and/or what the user was looking at. The conversation system 350 may provide the gesture-labelled digital human response 380 to the orchestration system 345 in the form of a gesture-labelled digital human response 390. Likewise, the orchestration system 345 may provide the gesture-labelled digital human response 390 to the current user environment with a digital human 310 in the form of a gesture-labelled digital human response and/or digital human adaptations 392, for presentation to the user, for example, using a user interface. The digital human adaptations may be based, at least in part, on the gesture-based digital human adaptations 335 generated by the gesture-based orientation module 330, as discussed above. In addition, the orchestration system 345 may navigate the user to a destination address, associated with the gesture-labelled digital human response and/or digital human adaptations 392, identifying a destination having additional information.

For example, a digital human may greet the user and invite the user, using one or more gestures, to make a selection from a virtual touch interface having selectable portions, for example, and the user may make a selection by pointing (or another gesture) at a desired area of the virtual touch interface. A haptic feedback signal 395 may also be provided by the orchestration system 345 to trigger the provision of haptic feedback to the user as positive feedback in connection with making the selection, or another gesture-related interaction, as discussed further below in conjunction with FIG. 7, for example.

The conversation system 350 may receive the results from the RAG-based information retrieval system 365 in some embodiments, generate the context-based prompts 370, make a call to the language model 375 to obtain the gesture-labelled digital human response 380 and store at least a portion of the gesture-labelled digital human response 380 in one or more of the persistent session context slots 355, before providing the gesture-labelled digital human response 390 to the orchestration system 345.

In one or more embodiments, the orchestration system 345 may be implemented, for example, using one or more Python scripts, or a Python application, to route signals from the components interconnected with the orchestration system 330 via one or more application programming interfaces (APIs), such as RESTful APIs generated using the fastAPI web framework. In at least some embodiments, the conversation system 350 may be implemented, at least in part, using Rasa conversational artificial intelligence software, commercially available from Rasa Technologies Inc.

FIG. 4 illustrates an exemplary processing of coordinates associated with a particular gesture to orient a digital human towards an area of the particular gesture in accordance with an illustrative embodiment. In the example of FIG. 4, the current X, Y coordinates 410 of a center of a bounding box (or another cropped image) associated with a particular gesture (such as the coordinates of a user hand associated with a given gesture), obtained, for example, from the gesture tracking model 325 of FIG. 3, are stored in an in-memory cache 420 of a three-dimensional graphics engine 400, such as the Unreal Engine three-dimensional computer graphics tool. In other examples, the current X, Y coordinates 410 may be an instruction for the digital human to initiate a gesture towards a location associated with the current X, Y coordinates 410, as discussed further below in conjunction with FIG. 7.

A plugin 430 of the three-dimensional graphics engine 400 reads the current X, Y coordinates 425 from the in-memory cache 420, and writes the current X, Y coordinates 435 to a data structure 440 of the three-dimensional graphics engine 400.

As shown in FIG. 4, one or more visual scripts 445, such as one or more visual scripts generated using the blueprint visual scripting system in the Unreal Engine to define object-oriented classes or objects. The one or more visual scripts 445 obtain a variable 442 comprising the current coordinates from the data structure 440 and instantiates a two-dimensional (2D) plane 455 with an object relationship. A three-dimensional (3D) shape 460 is instantiated on the two-dimensional (2D) plane 455, and the 3D shape 460 has a parent relationship with the 2D plane 455. The 3D shape 460 has an object relationship with the one or more visual scripts 445. As the one or more visual scripts 445 update the variable 442 the 3D shape 460 is updated to the current X, Y coordinates by the Unreal Engine.

A representation 470 of the instantiated 2D plane 455 comprises a representation 475 of the current position and orientation of the 3D shape 460. As the current position and orientation of the 3D shape 460 is updated, one or more adaptations 480 are generated that automatically orient a digital human towards the current position and orientation of the representation of the three-dimensional shape 475.

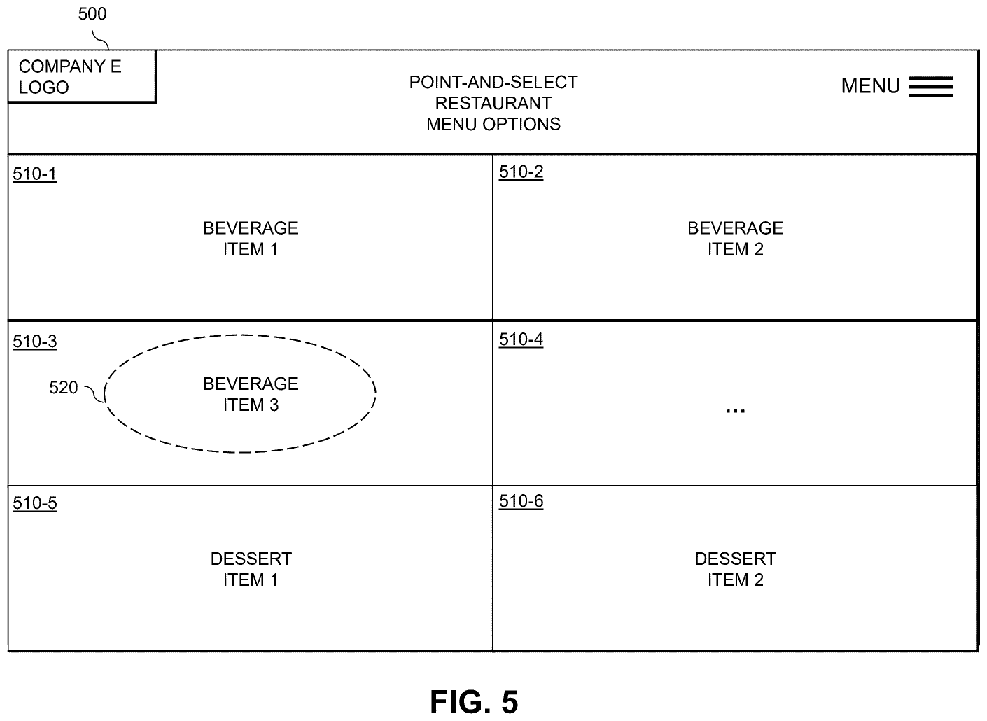

FIG. 5 illustrates an exemplary webpage 500 (e.g., of a given retailer, such as Company E), or another mechanism for visually presenting information to a user, in accordance with an illustrative embodiment. In the example of FIG. 5, the exemplary webpage 500 has a number of selectable portions 510-1 through 510-6 that may be of interest to a user, such as available item selections on a menu. For example, selectable portion 510-3 is associated with beverage item 3. The dashed circle 520 indicates that the selectable portion 510-3 is the current item selection for a particular user (indicated, for example, using the computer vision techniques described herein to detect a pointing gesture, for example, or another gesture to indicate a selection).

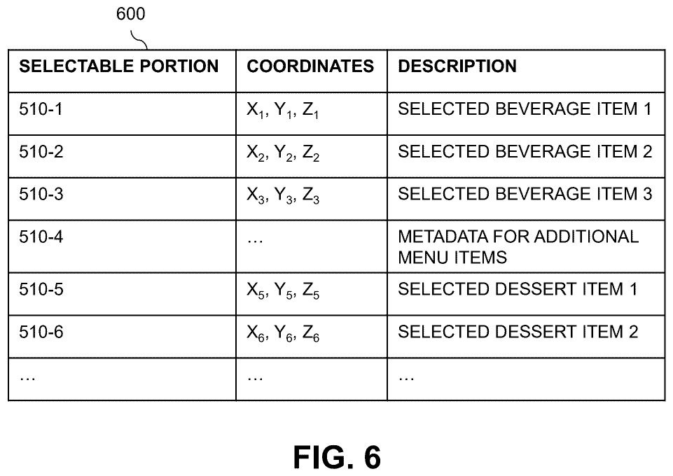

FIG. 6 is a sample table 600 illustrating metadata for the selectable portions of FIG. 5 that may be of interest to a user in accordance with an illustrative embodiment. In the example of FIG. 6, for each selectable portion 510 of FIG. 5, such as selectable portions 510-1 through 510-6, the corresponding metadata may identify the coordinates associated with the corresponding selectable portions 510 and provide a corresponding description of a selectable item associated with the corresponding selectable portions 510, and optionally any deals or sales associated with the selectable item. The coordinates associated with each selected portion, as indicated by a user gesture, may be provided as an input to the three-dimensional graphics engine 400 of FIG. 4, for example, as discussed above. In some embodiments, the x, y coordinates of a given gesture may be translated to coordinates using the metadata in the sample table 600 of FIG. 6. Similarly, x, y, z coordinates can be obtained for selectable portions (e.g., three-dimensional portions) of a virtual environment, in a similar manner as the webpage example of FIGS. 5 and 6, and the x, y, z coordinates of a given selected portion, as indicated by a user gesture, may be provided to the three-dimensional graphics engine 400 of FIG. 4, as would be apparent to a person of ordinary skill in the art.

FIG. 7 is a flow diagram illustrating an exemplary implementation of a process for gesture-based processing of digital human responses in accordance with an illustrative embodiment. The process of FIG. 7 may be performed, for example, for each gesture label in a digital human response. The process of FIG. 7 may be implemented, at least in some embodiments, by the orchestration system 345 of FIG. 3.

In the example of FIG. 7, a test is performed in step 710 to determine if a gesture-labelled response requires an evaluation of a user gesture (for example, by the gesture processing system 315). The user gesture may be based on, for example, one or more interactions with a virtual touch display having portions that are selectable by means of the user gesture (e.g., pointing to a desired selectable item). If it is determined in step 710 that gesture-labelled response being processed requires an evaluation of a user gesture, then a virtual touch display element (e.g., a virtual touch screen, such as in healthcare and/or restaurant implementations) having selectable portions, for example, is presented to the user in step 720. In addition, two or more coordinates of a user gesture in connection with the virtual touch display element, are detected in multiple dimensions, a haptic feedback response is optionally provided to user and the detected coordinates are mapped to an item selection using metadata (e.g., metadata from the sample table 600 of FIG. 6).

If, however, it is determined in step 710 that gesture-labelled response being processed does not require an evaluation of a user gesture, then a test is performed in step 730 to determine if the gesture-labelled response being processed requires a virtual interaction from a user to a digital human, or vice versa. The virtual interaction of step 730 may comprise, for example, a handshake, a first bump, a high five and/or a thumbs up (e.g., when called for by the conversational dialogue or initiated by the digital human, for example, to engage the user).

If it is determined in step 730 that the gesture-labelled response being processed requires a virtual interaction from the user to the digital human, then the coordinates of the user gesture are detected in step 740 and the gesture-based orientation module 330 is employed to orient a corresponding portion of the digital human towards a vicinity of coordinates. In addition, a haptic feedback response may optionally be provided to the user.

If, however, it is determined in step 730 that the gesture-labelled response being processed requires a virtual interaction from the digital human to the user, then the desired coordinates of a digital human gesture are applied to the gesture-based orientation module 330 to orient a designated portion of the digital human to a vicinity of the applied coordinates in step 750. In addition, a haptic feedback response may optionally be provided to the user, for example, when the user provides the appropriate virtual interaction to the digital human.

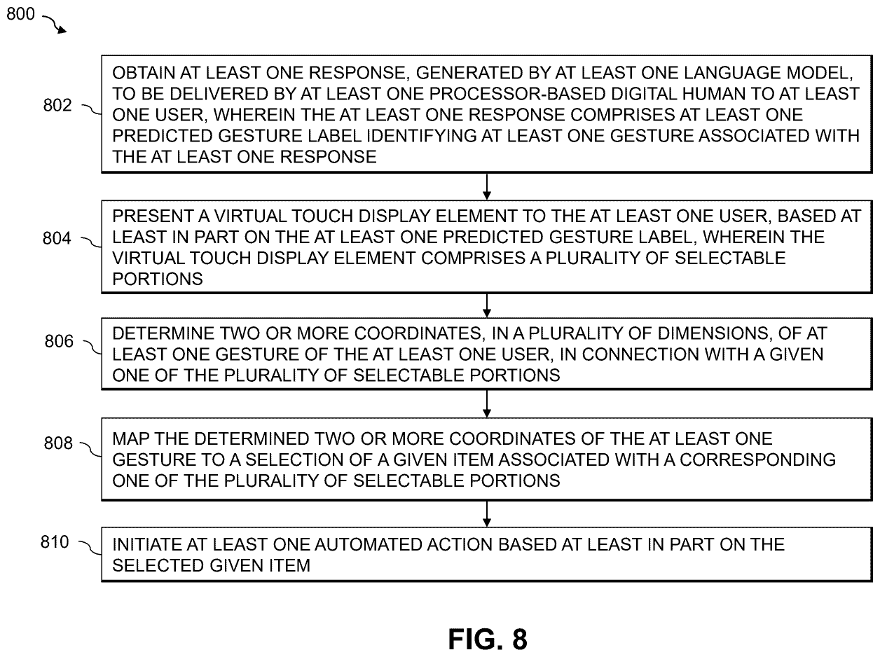

FIG. 8 is a flow diagram illustrating an exemplary implementation of a process 800 for gesture-based processing of digital human responses in accordance with an illustrative embodiment. In the example of FIG. 8, at least one response, generated by at least one language model, is obtained in step 802 to be delivered by at least one processor-based digital human to at least one user. The at least one response comprises at least one predicted gesture label identifying at least one gesture associated with the at least one response.

In step 804, a virtual touch display element is presented to the at least one user, based at least in part on the at least one predicted gesture label, wherein the virtual touch display element comprises a plurality of selectable portions. Two or more coordinates, in a plurality of dimensions, of at least one gesture of the at least one user is determined in step 806 in connection with a given one of the plurality of selectable portions. The determined two or more coordinates of the at least one gesture are mapped in step 808 to a selection of a given item associated with a corresponding one of the plurality of selectable portions, for example, using metadata. At least one automated action is initiated in step 810 based at least in part on the selected given item.

In at least one embodiment, a haptic feedback response is provided to the at least one user in response to the at least one gesture of the at least one user. The at least one predicted gesture label may be associated with a virtual interaction from the at least one processor-based digital human to the at least one user and the method may further comprises providing two or more coordinates, in a plurality of dimensions, to a graphics engine that extends a virtual representation of at least one body part of the at least one processor-based digital human towards at least one body part of the at least one user. A haptic feedback response maybe provided to the at least one user in response to the at least one user extending a corresponding at least one body part of the at least one user towards the virtual representation of the at least one body part of the at least one processor-based digital human.

In some embodiments, the at least one predicted gesture label is associated with a virtual interaction from the at least one user to the at least one processor-based digital human and further comprising determining two or more coordinates, in a plurality of dimensions, of at least one gesture of at least one body part of the at least one user towards the at least one processor-based digital human, associated with the virtual interaction, and extending a virtual representation of a corresponding at least one body part of the at least one processor-based digital human towards the at least one body part of the at least one user using a graphics engine. A haptic feedback response may be provided to the at least one user in response to the extending the virtual representation of the corresponding at least one body part of the at least one processor-based digital human towards the at least one body part of the at least one user. The virtual interaction from the at least one user to the at least one processor-based digital human may comprise one or more of a virtual handshake, a virtual first bump, a virtual high five and a virtual thumbs up.

In one or more embodiments, the at least one automated action may comprise generating one or more notifications related to the selected given item or another communication to one or more designated recipients regarding the selected given item; generating one or more signals related to the selected given item (for example, alerting another system of an availability of the selected given item, providing the selected given item to a display system and/or enabling a display of the selected given item); and/or controlling a performance of at least one action in another system using the selected given item (such as uploading the selected given item in the other system or otherwise storing the selected given item in the other system and/or initiating an automated review of the selected given item by the other system).

The particular processing operations and other network functionality described in conjunction with FIGS. 3, 7 and 8, for example, are presented by way of illustrative example only, and should not be construed as limiting the scope of the disclosure in any way. Alternative embodiments can use other types of processing operations for gesture-based processing of digital human responses. For example, the ordering of the process steps may be varied in other embodiments, or certain steps may be performed concurrently with one another rather than serially. In one aspect, the process can skip one or more of the steps. In other aspects, one or more of the steps are performed simultaneously. In some aspects, additional steps can be performed.

One or more embodiments of the disclosure provide improved methods, apparatus and computer program products for gesture-based processing of digital human responses. The foregoing applications and associated embodiments should be considered as illustrative only, and numerous other embodiments can be configured using the techniques disclosed herein, in a wide variety of different applications.

It should also be understood that the disclosed techniques for gesture-based processing of digital human responses, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for gesture-based processing of digital human responses may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute and/or storage services can be offered to cloud infrastructure tenants or other system users as a PaaS, IaaS, STaaS and/or FaaS offering, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based digital human adaptation engine, or portions thereof, are illustratively implemented for use by tenants of such a multi-tenant environment.

Cloud infrastructure as disclosed herein can include cloud-based systems. Virtual machines provided in such systems can be used to implement at least portions of a cloud-based digital human adaptation platform in illustrative embodiments. The cloud-based systems can include object stores.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

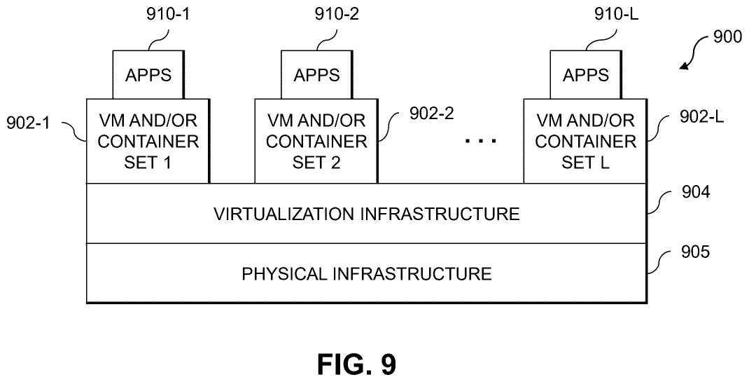

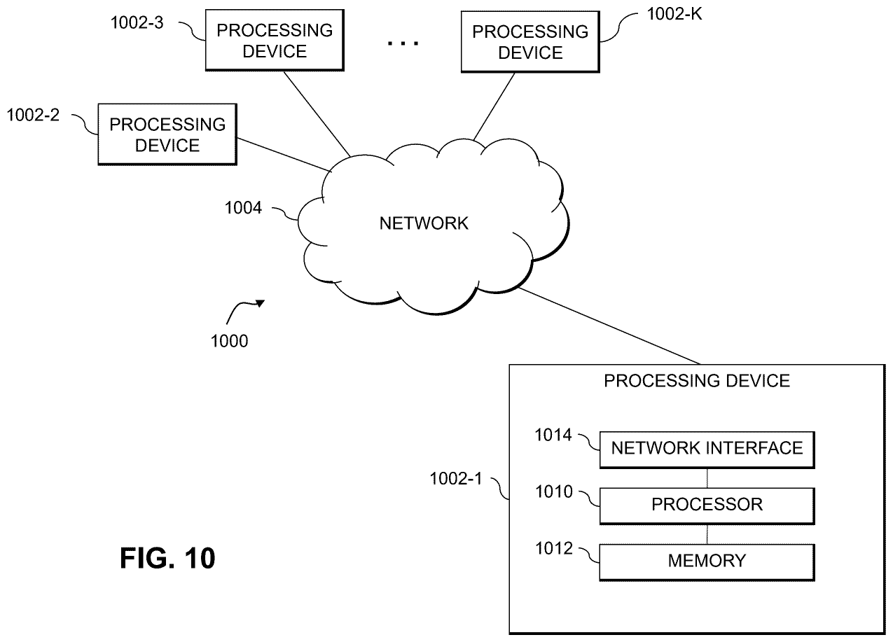

Illustrative embodiments of processing platforms will now be described in greater detail with reference to FIGS. 9 and 10. These platforms may also be used to implement at least portions of other information processing systems in other embodiments.

FIG. 9 shows an example processing platform comprising cloud infrastructure 900. The cloud infrastructure 900 comprises a combination of physical and virtual processing resources that may be utilized to implement at least a portion of the information processing system 100. The cloud infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 may comprise respective VMs, respective sets of one or more containers, or respective sets of one or more containers running in VMs.

In some implementations of the FIG. 9 embodiment, the VMs/container sets 902 comprise respective VMs implemented using virtualization infrastructure 904 that comprises at least one hypervisor. Such implementations can provide digital human adaptation functionality of the type described above for one or more processes running on a given one of the VMs. For example, each of the VMs can implement digital human adaptation control logic and associated functionality for gesture-based processing of digital human responses, for one or more processes running on that particular VM.

An example of a hypervisor platform that may be used to implement a hypervisor within the virtualization infrastructure 904 is a compute virtualization platform which may have an associated virtual infrastructure management system such as server management software. The underlying physical machines may comprise one or more distributed processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system. Such implementations can provide digital human adaptation functionality of the type described above for one or more processes running on different ones of the containers. For example, a container host device supporting multiple containers of one or more container sets can implement one or more instances of digital human adaptation control logic and associated functionality for gesture-based processing of digital human responses.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises at least a portion of the given system and includes a plurality of processing devices, denoted 1002-1, 1002-2, 1002-3, . . . 1002-K, which communicate with one another over a network 1004. The network 1004 may comprise any type of network, such as a WAN, a LAN, a satellite network, a telephone or cable network, a cellular network, a wireless network such as WiFi or WiMAX, or various portions or combinations of these and other types of networks.

The processing device 1002-1 in the processing platform 1000 comprises a processor 1010 coupled to a memory 1012. The processor 1010 may comprise a microprocessor, a microcontroller, an ASIC, an FPGA or other type of processing circuitry, as well as portions or combinations of such circuitry elements, and the memory 1012, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 9 or 10, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or 10 limitations of the disclosure. Numerous other alternative embodiments within the scope of the appended claims will be readily apparent to those skilled in the art.

What is claimed is:

1. A method, comprising:
obtaining at least one response, generated by at least one language model, to be delivered by at least one processor-based digital human to at least one user, wherein the at least one response comprises at least one predicted gesture label identifying at least one gesture associated with the at least one response;
presenting a virtual touch display element to the at least one user, based at least in part on the at least one predicted gesture label, wherein the virtual touch display element comprises a plurality of selectable portions;
determining two or more coordinates, in a plurality of dimensions, of at least one gesture of the at least one user, in connection with a given one of the plurality of selectable portions;
mapping the determined two or more coordinates of the at least one gesture to a selection of a given item associated with a corresponding one of the plurality of selectable portions; and
initiating at least one automated action based at least in part on the selected given item;
wherein the method is performed by at least one processing device comprising a processor coupled to a memory.

2. The method of claim 1, further comprising providing a haptic feedback response to the at least one user in response to the at least one gesture of the at least one user.

3. The method of claim 1, wherein the at least one predicted gesture label is associated with a virtual interaction from the at least one user to the at least one processor-based digital human and further comprising determining two or more coordinates, in a plurality of dimensions, of at least one gesture of at least one body part of the at least one user towards the at least one processor-based digital human, associated with the virtual interaction, and extending a virtual representation of a corresponding at least one body part of the at least one processor-based digital human towards the at least one body part of the at least one user using a graphics engine.

4. The method of claim 3, further comprising providing a haptic feedback response to the at least one user in response to the extending the virtual representation of the corresponding at least one body part of the at least one processor-based digital human towards the at least one body part of the at least one user.

5. The method of claim 3, wherein the virtual interaction from the at least one user to the at least one processor-based digital human comprises one or more of a virtual handshake, a virtual first bump, a virtual high five and a virtual thumbs up.

6. The method of claim 1, wherein the at least one predicted gesture label is associated with a virtual interaction from the at least one processor-based digital human to the at least one user and further comprising providing two or more coordinates, in a plurality of dimensions, to a graphics engine that extends a virtual representation of at least one body part of the at least one processor-based digital human towards at least one body part of the at least one user.

7. The method of claim 6, further comprising providing a haptic feedback response to the at least one user in response to the at least one user extending a corresponding at least one body part of the at least one user towards the virtual representation of the at least one body part of the at least one processor-based digital human.

8. The method of claim 1, wherein the at least one automated action comprises one or more of generating one or more notifications related to the selected given item; generating one or more signals related to the selected given item; and controlling a performance of at least one action in another system using the selected given item.

9. An apparatus comprising:
at least one processing device comprising a processor coupled to a memory;
the at least one processing device being configured to implement the following steps:
obtaining at least one response, generated by at least one language model, to be delivered by at least one processor-based digital human to at least one user, wherein the at least one response comprises at least one predicted gesture label identifying at least one gesture associated with the at least one response;
presenting a virtual touch display element to the at least one user, based at least in part on the at least one predicted gesture label, wherein the virtual touch display element comprises a plurality of selectable portions;
determining two or more coordinates, in a plurality of dimensions, of at least one gesture of the at least one user, in connection with a given one of the plurality of selectable portions;
mapping the determined two or more coordinates of the at least one gesture to a selection of a given item associated with a corresponding one of the plurality of selectable portions; and
initiating at least one automated action based at least in part on the selected given item.

10. The apparatus of claim 9, further comprising providing a haptic feedback response to the at least one user in response to the at least one gesture of the at least one user.

11. The apparatus of claim 9, wherein the at least one predicted gesture label is associated with a virtual interaction from the at least one user to the at least one processor-based digital human and further comprising determining two or more coordinates, in a plurality of dimensions, of at least one gesture of at least one body part of the at least one user towards the at least one processor-based digital human, associated with the virtual interaction, and extending a virtual representation of a corresponding at least one body part of the at least one processor-based digital human towards the at least one body part of the at least one user using a graphics engine.

12. The apparatus of claim 11, further comprising providing a haptic feedback response to the at least one user in response to the extending the virtual representation of the corresponding at least one body part of the at least one processor-based digital human towards the at least one body part of the at least one user.

13. The apparatus of claim 9, wherein the at least one predicted gesture label is associated with a virtual interaction from the at least one processor-based digital human to the at least one user and further comprising providing two or more coordinates, in a plurality of dimensions, to a graphics engine that extends a virtual representation of at least one body part of the at least one processor-based digital human towards at least one body part of the at least one user.

14. The apparatus of claim 13, further comprising providing a haptic feedback response to the at least one user in response to the at least one user extending a corresponding at least one body part of the at least one user towards the virtual representation of the at least one body part of the at least one processor-based digital human.

15. A non-transitory processor-readable storage medium having stored therein program code of one or more software programs, wherein the program code when executed by at least one processing device causes the at least one processing device to perform the following steps:
obtaining at least one response, generated by at least one language model, to be delivered by at least one processor-based digital human to at least one user, wherein the at least one response comprises at least one predicted gesture label identifying at least one gesture associated with the at least one response;
presenting a virtual touch display element to the at least one user, based at least in part on the at least one predicted gesture label, wherein the virtual touch display element comprises a plurality of selectable portions;
determining two or more coordinates, in a plurality of dimensions, of at least one gesture of the at least one user, in connection with a given one of the plurality of selectable portions;
mapping the determined two or more coordinates of the at least one gesture to a selection of a given item associated with a corresponding one of the plurality of selectable portions; and
initiating at least one automated action based at least in part on the selected given item.

16. The non-transitory processor-readable storage medium of claim 15, further comprising providing a haptic feedback response to the at least one user in response to the at least one gesture of the at least one user.

17. The non-transitory processor-readable storage medium of claim 15, wherein the at least one predicted gesture label is associated with a virtual interaction from the at least one user to the at least one processor-based digital human and further comprising determining two or more coordinates, in a plurality of dimensions, of at least one gesture of at least one body part of the at least one user towards the at least one processor-based digital human, associated with the virtual interaction, and extending a virtual representation of a corresponding at least one body part of the at least one processor-based digital human towards the at least one body part of the at least one user using a graphics engine.

18. The non-transitory processor-readable storage medium of claim 17, further comprising providing a haptic feedback response to the at least one user in response to the extending the virtual representation of the corresponding at least one body part of the at least one processor-based digital human towards the at least one body part of the at least one user.

19. The non-transitory processor-readable storage medium of claim 15, wherein the at least one predicted gesture label is associated with a virtual interaction from the at least one processor-based digital human to the at least one user and further comprising providing two or more coordinates, in a plurality of dimensions, to a graphics engine that extends a virtual representation of at least one body part of the at least one processor-based digital human towards at least one body part of the at least one user.

20. The non-transitory processor-readable storage medium of claim 19, further comprising providing a haptic feedback response to the at least one user in response to the at least one user extending a corresponding at least one body part of the at least one user towards the virtual representation of the at least one body part of the at least one processor-based digital human.
